(19) United States
(12) Patent Application Publication
(10) Pub. No.: US 2013/0309878 A1
(43) Pub. Date: Nov. 21, 2013

(54) PLUG EXTRACTION TEST APPARATUS

(71) Applicant: Hong-Wei LEE, New Taipei City (TW)

(72) Inventor: Hong-Wei LEE, New Taipei City (TW)

(21) Appl. No.: 13/610,276

(22) Filed: Sep. 11, 2012

(30) Foreign Application Priority Data
May 21, 2012 (CN) 201210159610.7

(51) Int. Cl. H01R 12/75

(52) U.S. Cl. 439/74

(57) ABSTRACT

A plug extraction test apparatus is disclosed. The plug extraction test apparatus is used for electrically connecting a device to be tested that has an adapter to a testing host, wherein the plug extraction test apparatus includes a first circuit board and a second circuit board. The first circuit board includes at least one connection port and at least one first slot, wherein the at least one connection port allows the adapter to be plugged into it. The second circuit board includes a plurality of conductive contacts used for being electrically connected to the testing host, such that an electrical signal in the second circuit board is transmitted to the testing host. The second circuit board is electrically connected to the first circuit board via the first slot so that an electrical signal in the first circuit board is transmitted to the second circuit.

### BACKGROUND OF THE INVENTION

1. Field of the Invention

The present invention relates to a plug extraction test apparatus, especially to a plug extraction test apparatus having independently disposed circuit boards, and the circuit boards are not welded together.

2. Description of the Related Art

Please refer to FIG. 1, in which an existed plug extraction test apparatus is shown. FIG. 1 is a schematic diagram of an internal circuit board in an automatic plug extraction test box. As shown in FIG. 1, the existing plug extraction test box has two first circuit boards 10a and a second circuit board 20a disposed therein. Two first circuit boards 10a have several different connection ports disposed thereon, such that the device to be tested can be plugged therein via an adapter. The second circuit board 20a is provided to electrically connect with a testing host such that the electrical signals of the two first circuit boards 10a can be transmitted to the second circuit board 20a; thus the device to be tested can be electrically connected with the testing host via the automatic plug extraction test box, and the signals or information of the device to be tested can be displayed on the testing host (the testing host is connected to a display screen).

The existing automatic plug extraction test box has two first circuit boards 10a and one second circuit board 20a disposed therein that are welded together as a whole, such that if one of the circuit boards fails, replacing the failed circuit board will be impossible and the whole box will have to be discarded, thus wasting materials and increasing the cost.

Therefore, a new plug extraction test apparatus is needed to solve the aforementioned problem in the prior art.

### SUMMARY OF THE INVENTION

It is a primary object of the present invention to provide a plug extraction test apparatus.

To achieve the above object, a plug extraction test apparatus for electrically connecting a device to be tested having an adapter to a testing host is disclosed. The plug extraction test apparatus includes a first circuit board and a second circuit board. The first circuit board includes at least one connection port and at least one first slot, and the at least one connection port is provided for plugging the adapter therein. The second circuit board includes a plurality of conductive contacts for electrically connecting to the testing host, thereby transmitting electrical signals of the second circuit board to the testing host, wherein the second circuit board is electrically connected to the first circuit board via the first slot, thereby transmitting electrical signals of the first circuit board to the second circuit board.

The plug extraction test apparatus of the present invention comprises a first circuit board and a second circuit board. The first circuit board includes at least one connection port for plugging the adapter therein. The second circuit board includes a plurality of conductive contacts and at least one second slot, and the plurality of conductive contacts is used for electrically connecting to the testing host, thereby transmitting electrical signals of the second circuit board to the testing host, wherein the first circuit board is electrically connected to the second circuit board via the second slot, thereby transmitting electrical signals of the first circuit board to the second circuit board.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a schematic diagram of an internal circuit board in a plug extraction test apparatus according to a prior art.

FIG. 2 is a schematic diagram of electrically connecting a device to be tested to a plug extraction test apparatus according to an embodiment of the invention.

FIG. 3 is a schematic diagram of electrically connecting a testing host to the plug extraction test apparatus according to an embodiment of the invention.

FIG. 4 is a schematic diagram of decomposing the plug extraction test apparatus according to an embodiment of the invention.

### DETAILED DESCRIPTION OF THE PREFERRED EMBODIMENT

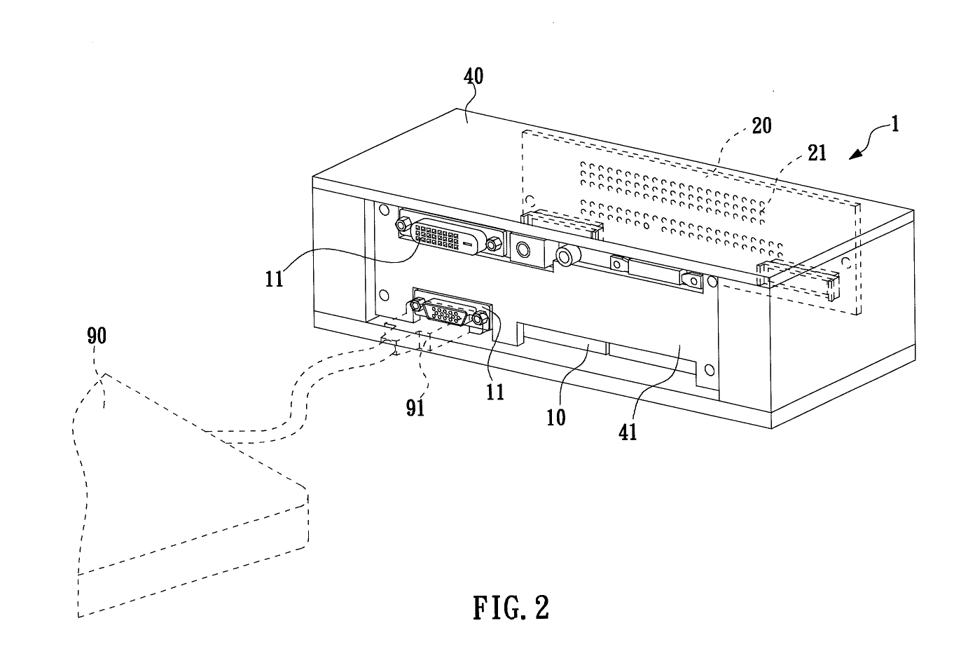

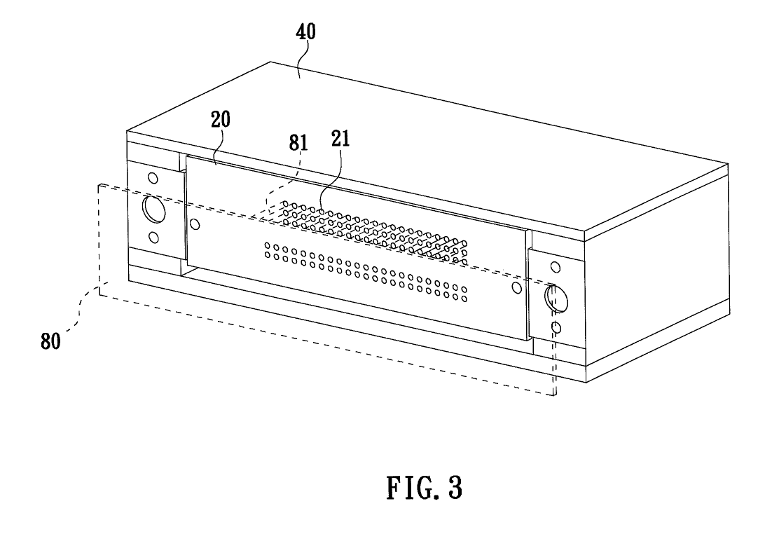

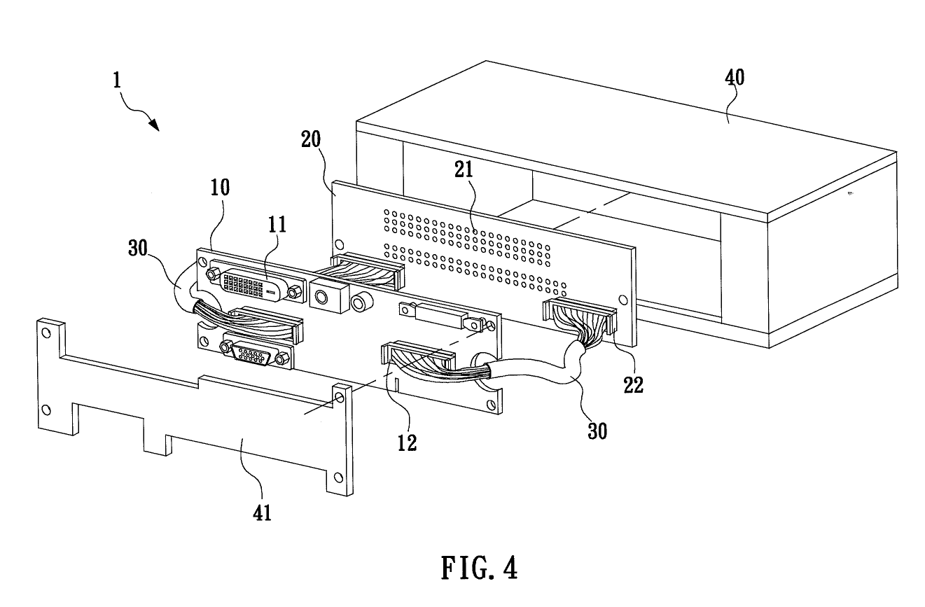

Please refer to FIG. 2 to FIG. 4 at the same time. FIG. 2 is a schematic diagram of electrically connecting a device to be tested to a plug extraction test apparatus according to an embodiment of the invention. FIG. 3 is a schematic diagram of electrically connecting a testing host to the plug extraction test apparatus according to an embodiment of the invention. FIG. 4 is a schematic diagram of decomposing the plug extraction test apparatus according to an embodiment of the invention.

In one embodiment of the present invention, the plug extraction test apparatus of the present invention is an automatic plug extraction test box, i.e., an I-BOX, but the present invention is not limited to it.

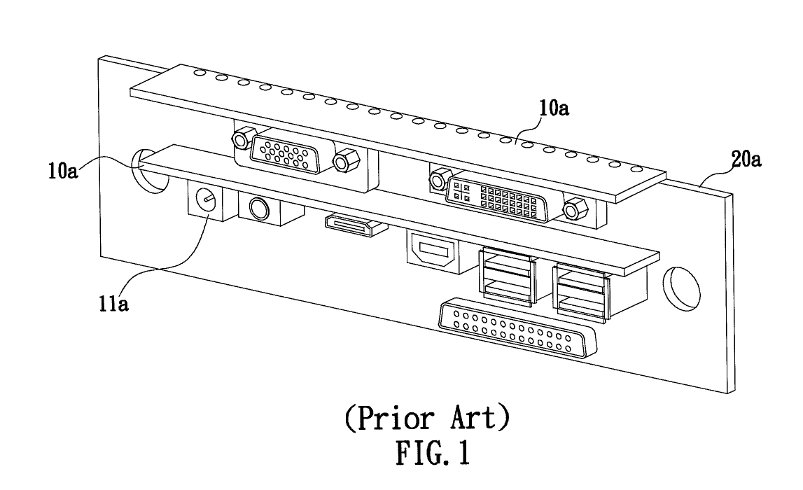

As shown in FIG. 2 and FIG. 3, the plug extraction test apparatus 1 is used for a device to be tested 90 having an adapter 91 being electrically connected to a testing host 80 through the plug extraction test apparatus 1. As shown in FIG. 1 and FIG. 2, in one embodiment of the present invention, the plug extraction test apparatus 1 of the present invention includes a first circuit board 10, a second circuit board 20, two transmission devices 30, and a base 40.

As shown in FIG. 2 and FIG. 4, in one embodiment of the present invention, the first circuit board 10 is connected and fixed on one side surface of the base 40, and the first circuit board 10 includes at least one connection port 11 and at least one first slot 12. The at least one connection port 11 is provided for plugging the adapter 91 of the device to be tested 90 therein. In the specific embodiment of the present invention, the number of the at least one connection port 11 is more than one, and the connection port 11 could be a VGA connection port, a DVI connection port, an HDMI connection port, a USB connection port, or a combination of the aforementioned ports. However, the present invention is not limited to these examples. In the specific embodiment of the present invention, the number of the first slots 12 is two, but the present invention is not limited to it.

As shown in FIG. 3 and FIG. 4, in one embodiment of the present invention, the second circuit board 20 is connected and fixed on another side surface of the base 40, and the first circuit board 10 and the second circuit board 20 are disposed parallel and correspondingly to each other. The second circuit board 20 includes a plurality of conductive contacts 21 and at least one second slot 22. The plurality of conductive contacts 21 are used for electrically connecting the second circuit board 20 to the testing host 80 through contact with a probe 81, thereby transmitting electrical signals of the second circuit board 20 to the testing host 80. In the specific embodiment of the present invention, the number of the second slots 22 is two, but the present invention is not limited to it.

One end of the transmission device 30 is inserted into the first slot 12, and another end of the transmission device 30 is inserted into the second slot 22, thereby electrically connecting the first circuit board 10 and the second circuit board 20 through the transmission device 30, and further transmitting electrical signals between the first circuit board 10 and the second circuit board 20. In the specific embodiment of the present invention, the transmission device 30 could be a transmission line, but the present invention is not limited to it; the transmission device 30 could also be any device having a function of transmitting electrical signals such as a flexible board or an electrical connector.

In one embodiment of the present invention, the base 40 is a hollow base body, and the first circuit board 10 and the second circuit board 20 cover two corresponding side surfaces of the base 40 respectively. Screws (not shown in the figure) are used to fasten the first circuit board 10 and the second circuit board 20 on the base 40. The base 40 includes a cover 41 used for covering the first circuit board 10 to protect the first circuit board 10. After assembly, the transmission device 30 is hidden in the hollow base 40.

It must be noted that the afore-described implementation are just preferred embodiments of the present invention, and for simplification of the description, not all of the possible variants are recorded here. However, those skilled in the art could understand that the aforementioned devices are not all necessary. In addition, in order to implement the present invention, some conventional devices could be included, and each device may be cancelled or modified case by case. For example, an edge connector (commonly refer to as a “golden finger”) could be disposed on the second circuit board 20, and thus the second circuit board 20 could be plugged in the first slot 12 via the edge connector, and the transmission device 30 and the second slot 22 could be omitted. It must be noted that if the connection is completed by the aforementioned method, it will be possible to plug the first circuit board 10 into the second slot 22, and thus the transmission device 30 and the first slot 12 will be omitted in such a case.

Because the first circuit board 10 and the second circuit board 20 of the plug extraction test apparatus 1 according to the present invention are electrically connected with each other through the slot, and two circuit boards are separated independently and not welded together. If one of the first circuit board 10 and the second circuit board 20 fails, the failed circuit board can be replaced by simply removing the transmission device 30 from the failed circuit board, and the un-failed circuit board can be kept and continually used. In such a way, the whole apparatus will not have to be discarded when one of the circuit boards fails, as described in the prior art, and the goal of reducing cost and material wastage can be achieved.

In summary, regardless of the function, the method and result of the present invention are shown to have technical characteristics different from the prior arts, and said method and result constitute a significant advance in the field. It is hoped that the examiners will appreciate the novelty of the present invention and grant this patent so as to benefit society. However, the aforementioned embodiments are just for illustration of the principle and the result of the present invention and should not be construed to limit the range of the present invention. It will be obvious to those skilled in the art that, based upon the content herein, changes and modifications may be made without departing from the spirit and scope of the present invention. Therefore, the appended claims are intended to encompass within their scope all such changes and modifications as are within the true spirit and scope of the exemplary embodiment(s) of the present invention.

What is claimed is:

1. A plug extraction test apparatus, for electrically connecting a device to be tested having an adapter to a testing host, the plug extraction test apparatus comprising:
a first circuit board, comprising at least one connection port and at least one first slot, wherein the at least one connection port is provided for plugging the adapter therein; and
a second circuit board, comprising a plurality of conductive contacts used for being electrically connected to the testing host, thereby transmitting electrical signals of the second circuit board to the testing host, wherein the second circuit board is electrically connected to the first circuit board via the first slot, thereby transmitting electrical signals of the first circuit board to the second circuit board.

2. The plug extraction test apparatus as claim 1, further comprising at least one transmission device, the second circuit board further comprising at least one second slot, one end of the at least one transmission device being inserted into the at least one first slot, and another end of the at least one transmission device being inserted into the at least one second slot.

3. The plug extraction test apparatus as claim 2, further comprising a base, and the first circuit board and the second circuit board are connected to and fixed on the base respectively, the first circuit board and the second circuit board being disposed parallel and correspondingly to each other.

4. The plug extraction test apparatus as claim 3, wherein the at least one transmission device is a transmission line.

5. The plug extraction test apparatus as claim 4, wherein the at least one connection port could be a VGA connection port, a DVI connection port, an HDMI connection port, or a USB connection port.

6. The plug extraction test apparatus as claim 5, wherein the number of the first slots is two, and the number of the second slots is two.

7. A plug extraction test apparatus, for electrically connecting a device to be tested having an adapter to a testing host, the plug extraction test apparatus comprising:
a first circuit board, comprising at least one connection port, and the at least one connection port is provided for plugging the adapter therein; and
a second circuit board, comprising a plurality of conductive contacts and at least one second slot, wherein the plurality of conductive contacts is used for electrically connecting to the testing host, thereby transmitting electrical signals of the second circuit board to the testing host, and the first circuit board is electrically connected to the second circuit board via the second slot, thereby transmitting electrical signals of the first circuit board to the second circuit board.
